(19) United States
(12) Patent Application Publication
(10) Pub. No.: US 2026/0140821 A1
(43) Pub. Date: May 21, 2026

(54) ERROR CORRECTION CODING DECODE BYPASS

(71) Applicant: Micron Technology, Inc., Boise, ID (US)

(72) Inventors: Leon Zlotnik, Camino, CA (US); Eyal En Gad, Highland, CA (US)

(21) Appl. No.: 19/377,986

(22) Filed: Nov. 3, 2025

Related U.S. Application Data
(60) Provisional application No. 63/721,919, filed on Nov. 18, 2024.

(51) Int. Cl. G06F 11/10

(52) U.S. Cl. CPC G06F 11/1052; G06F 11/1004; G06F 11/1068

(57) ABSTRACT

A method and system for optimizing decoding of error correction coding (ECC) in memory devices using a bypass technique. The system performs an error detection calculation on incoming codewords to identify error-free data, allowing it to bypass the ECC decoder and directly place the codeword into an output buffer, reducing power consumption and latency. The method includes dividing codewords into multiple blocks for separate error detection, processing only those blocks that fail. It also features dynamic bypass deactivation based on device metrics, ensuring robust error correction under varying conditions.

### PRIORITY APPLICATION

This application claims the benefit of priority to U.S. Provisional Application Ser. No. 63/721,919, filed Nov. 18, 2024, which is incorporated herein by reference in its entirety.

### TECHNICAL FIELD

Embodiments pertain to error correction technologies. Some embodiments relate to methods for optimizing decoding using error check bypass techniques.

### BACKGROUND

In modern communication and data storage systems, ensuring the integrity and reliability of data is paramount. As data is transmitted over networks or stored in memory devices, it is susceptible to errors due to noise, interference, or hardware malfunctions. To address these challenges, error detection and correction codes are employed to detect and correct errors, thereby enhancing data reliability.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a logical diagram of a computing device performing an ECC check according to some examples of the present disclosure.

FIG. 2 shows a logical diagram of a memory device implementing an error check bypass for ECC decoding according to some examples of the present disclosure.

FIG. 3 shows a logical diagram of a memory device implementing an error check bypass for ECC decoding according to some examples of the present disclosure.

FIG. 4 illustrates an example computing environment including a memory system 410, in accordance with some examples of the present disclosure.

FIG. 5 illustrates a computing system according to some examples of the present disclosure.

FIG. 6 illustrates a flowchart of a method of ECC decoding bypass according to some examples of the present disclosure.

FIG. 7 illustrates a diagram showing a single codeword broken into N portions with CRC data for each portion according to some examples of the present disclosure.

FIG. 8 is a block diagram illustrating an example of a machine upon which one or more embodiments may be implemented according to some examples of the present disclosure.

### DETAILED DESCRIPTION

Error Correction Codes (ECC) such as Low-Density Parity-Check (LDPC) codes are used in digital communication and data storage systems to detect and correct errors in transmitted or stored data. ECC codes may include Hamming codes, Reed-Solomon codes, Turbo Codes, and LDPC codes. LDPC codes, for example, are a widely used type of error-correcting code used to detect and correct errors in data transmission or storage. They are characterized by a sparse parity-check matrix, which allows for efficient error correction with relatively low computational complexity. LDPC codes are widely used in various communication systems, including digital television, wireless networks, and data storage devices, due to their ability to approach the Shannon limit of channel capacity.

The decoding process for LDPC codes typically involves iterative algorithms, such as the belief propagation or sum-product algorithm, which iteratively update the probabilities of bit values based on the received data and the parity-check matrix. This iterative process continues until a valid codeword is found or a maximum number of iterations is reached. LDPC codes are known for their robustness and efficiency, making them a popular choice for modern communication systems.

In some applications, in addition to an ECC code, other error detection and/or correction codes may be employed along with the ECC code. For example, Cyclic Redundancy Check (CRC) is an error detection technique that generates a fixed-size check value (checksum) for a block of data. This checksum is appended to the data before transmission or storage. CRC allows for the detection of various errors, including single-bit errors, burst errors, and some multiple-bit errors. CRC is popular because it is both robust and simple to implement. For example, one CRC algorithm is simply to apply a logical-XOR operation to the bits in the block of data and store the result.

In some systems, data stored or received is first decoded with ECC codes such as LDPC, and then the decoded data is checked with CRC or some other error detection mechanism to ensure correctness of the decoded data. By layering these approaches, systems may achieve higher reliability.

ECC decoding may be resource intensive. For example, LDPC decoding typically involve processing all codewords through a series of steps, regardless of whether they contain errors. One significant drawback of these traditional methods is the inefficiency in handling error-free codewords, which have a Bit Error Rate (BER) of zero. Despite being error-free, these codewords still pass through the entire ECC processing pipeline, consuming power and time unnecessarily. This inefficiency is particularly evident in scenarios where a substantial portion of the codewords are error-free, leading to wasted computational resources and increased latency.

Efforts to optimize this process have included attempts to reduce the time or resources required for decoding and to improve the accuracy of error detection. However, these methods still involve processing all codewords through the initial stages of ECC decoding, which does not address the core issue of unnecessary resource usage for error-free codewords. As a result, there remains a need for a more efficient approach that can effectively bypass the ECC processing for codewords without errors, thereby conserving power and improving overall system performance.

Disclosed in some examples are systems, methods, machine-readable mediums, and devices for optimizing decoding by implementing an error-detection bypass technique. This approach involves performing an error detection calculation check (e.g., CRC) to determine if a codeword is error-free. If the codeword is error free, the codeword is directly forwarded to the output, bypassing the entire ECC processing stage. If the codeword is not error-free, it is then decoded with the ECC. This method significantly reduces power consumption and latency by avoiding unnecessary processing of error-free codewords, thereby enhancing overall system performance and efficiency.

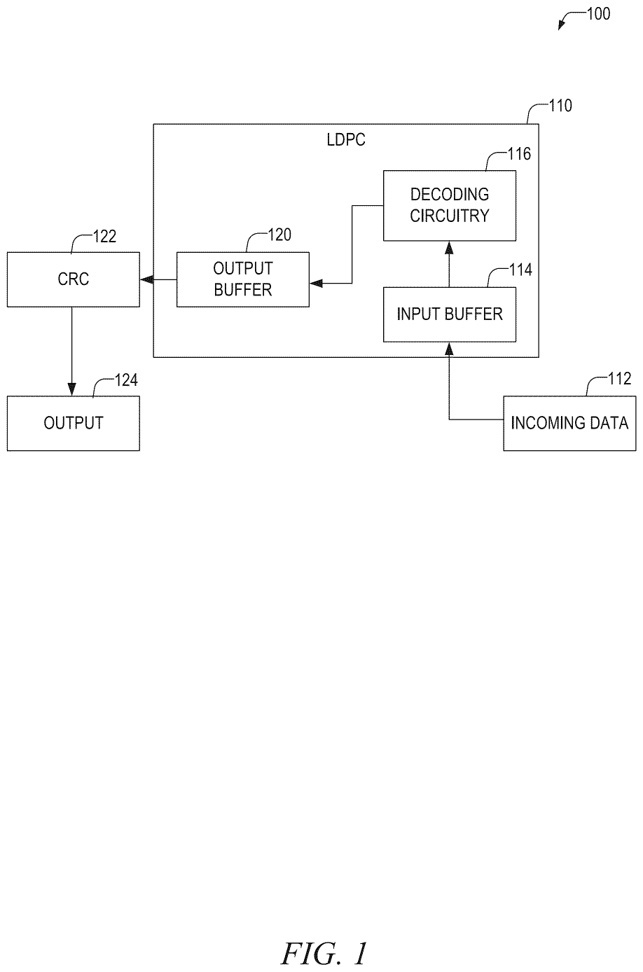

FIG. 1 shows a logical diagram 100 of a computing device performing an LDPC check according to some examples of the present disclosure. In the example of FIG. 1, the ECC algorithm is LDPC, but one of ordinary skill in the art with the benefit of the present disclosure will appreciate that the techniques disclosed herein are applicable to other ECC codes. The LDPC circuit 110 receives incoming data 112 and buffers it in an input buffer 114. The codewords are then sent to decoding circuitry. Codewords that are successfully decoded by the decoding circuitry 116 are passed to the output buffer 120. The output buffer 120 stores processed codewords after they are decoded. CRC circuitry 122 performs a Cyclic Redundancy Check on the decoded codewords to determine their error status. If the CRC passes, the codeword may be output 124. In FIG. 1, all data is processed through the LDPC circuit 110 regardless of whether they would ultimately pass CRC checks done by CRC circuitry 122. This may waste processing done by the LDPC circuit 110.

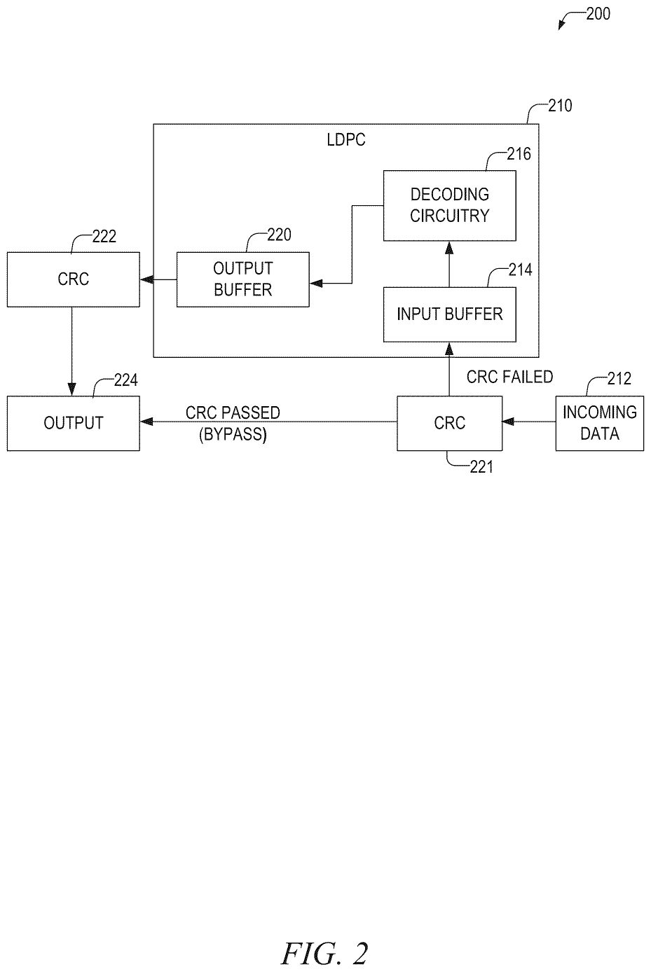

FIG. 2 shows a logical diagram 200 of a memory device implementing an error check bypass for ECC decoding according to some examples of the present disclosure. In the example of FIG. 2, the ECC algorithm is LDPC, but one of ordinary skill in the art with the benefit of the present disclosure will appreciate that the techniques disclosed herein are applicable to other ECC codes. In some examples, the disclosed techniques will work for other ECC codes, such as those that do not fundamentally change the data stored. For example, LDPC, Hamming codes, BCH codes, Reed-Solomon codes and the like may be used.

Incoming data 212 is first sent to an error detection circuit, such as a CRC circuit 221 to determine the error status of the codewords. If the CRC passes, the codeword bypasses the LDPC circuit 210 and is sent directly to the output 224, thus avoiding unnecessary processing. This bypass mechanism significantly reduces power consumption and latency by preventing error-free codewords from undergoing the full LDPC decoding process.

If the CRC fails, the codeword is processed by the LDPC circuit 210. The codewords may be first buffered in an input buffer 214. The codewords may then be processed by the decoding circuitry 216. The processed codewords that were successfully decoded may then be buffered in output buffer 220. CRC circuitry 222 then does a CRC check on the processed codewords before they are output 224. Codewords that pass the CRC check are sent to the output 224. In some examples, CRC circuitry 222 and 221 may be a same CRC circuitry or different CRC circuitry.

This configuration allows for efficient handling of codewords by utilizing the CRC check to determine if LDPC processing occurs, thereby optimizing the overall performance of the memory device.

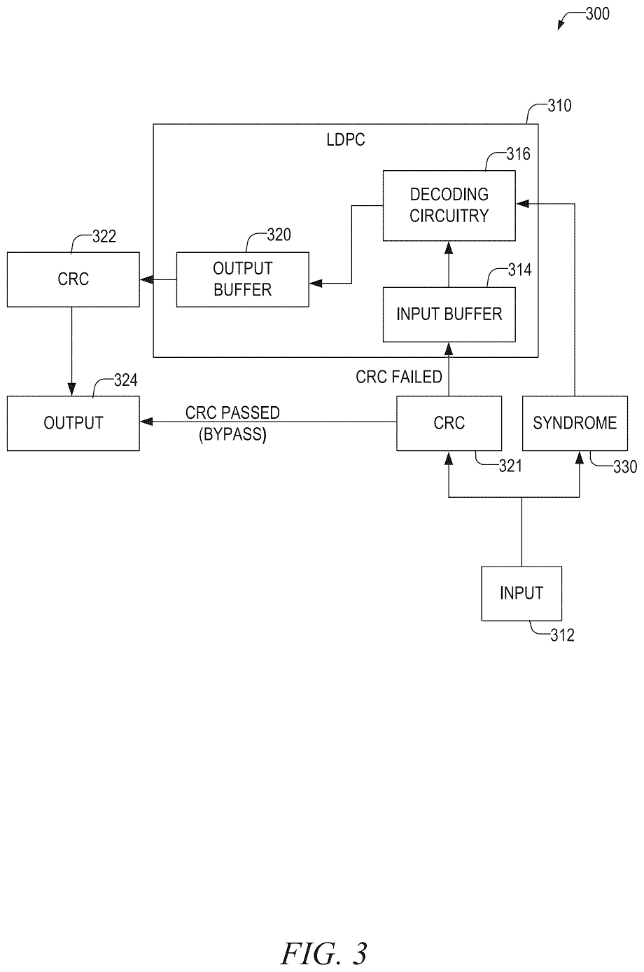

FIG. 3 shows a logical diagram 300 of a memory device implementing an error check bypass for ECC decoding according to some examples of the present disclosure. In the example of FIG. 3, the ECC algorithm is LDPC, but one of ordinary skill in the art with the benefit of the present disclosure will appreciate that the techniques disclosed herein are applicable to other ECC codes. Incoming data 312 is first sent to an error detection circuit, such as CRC circuit 321, to determine the error status of the codewords. If the CRC passes, the codeword bypasses the LDPC circuit 310 and is sent directly to the output 324, thus avoiding unnecessary processing. This bypass mechanism significantly reduces power consumption and latency by preventing error-free codewords from undergoing the full LDPC decoding process.

If the CRC fails, the codeword is processed by the LDPC circuit 310. The codewords may be first buffered in an input buffer 314. Codewords that are successfully decoded by the decoding circuitry 316 may be sent to an output buffer 320. CRC circuitry 322 then does a CRC check on the processed codewords before they are output 324. Codewords that pass the CRC check are sent to the output 324. In some examples, CRC circuitry 322 and 321 may be a same CRC circuitry or different CRC circuitry.

This configuration allows for efficient handling of codewords by utilizing the CRC check to determine if LDPC processing occurs, thereby optimizing the overall performance of the memory device.

FIG. 3 also illustrates the integration of syndrome calculation in parallel with the CRC check. The syndrome circuitry 330 calculates the LDPC syndrome and if the codeword fails CRC checks, the syndrome is passed to the decoding circuitry 316. This configuration allows for efficient handling of codewords by utilizing the CRC check to determine if LDPC processing should occur, thereby optimizing the overall performance of the memory device. In addition, by calculating the syndrome in parallel, further efficiencies as the HED 316 does not have to waste time to calculate a syndrome, as this is done in parallel with the CRC check.

The illustrated techniques herein may be applied to a number of distinct computing environments. One example environment is a memory device. The memory device may store LDPC and CRC encoded data to storage (volatile or non-volatile) and a memory controller may, prior to transmitting it to a host system, decode the data. For example, a memory controller may include the components of FIGS. 1-3.

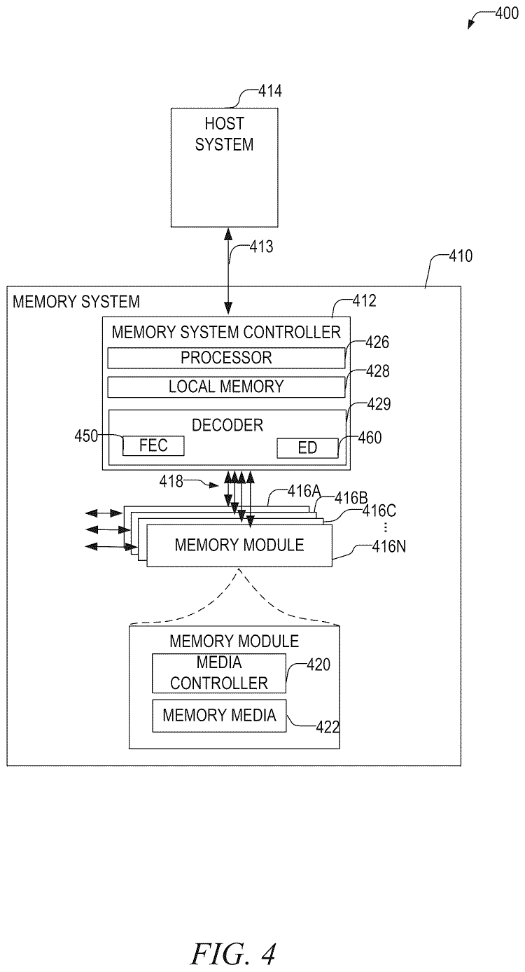

FIG. 4 illustrates an example computing environment 400 including a memory system 410, in accordance with some examples of the present disclosure. In some examples the memory system 410 can be volatile storage such as Random Access Memory (RAM), cache memory, dynamic RAM (DRAM), synchronous DRAM (SDRAM), double data rate SDRAM (DDR), static RAM (SRAM), Graphics DDR (GDDR), or the like. In some examples, the memory system 410 can be non-volatile storage such as a Not-AND (NAND) flash, NOR flash, magnetic storage (e.g., a hard-disk drive), tape storage, or the like. In some examples, the memory system 410 can include both volatile and non-volatile storage, by utilizing, for example, memory modules 416A-N containing different types of memory media 422 or by utilizing one or more single memory modules that include both volatile and non-volatile memory media 422. The memory system 410 may be an error-correcting memory system in that at least some of the memory media 422 includes error correcting memory.

In an example, the memory system 410 can be a discrete memory and/or storage device component of a host system. In other examples, the memory system 410 can be a portion of an integrated circuit (e.g., system on a chip (SOC), etc.), stacked or otherwise included with one or more other components of a host system. In some examples, the memory system 410 may be part of a distributed memory system with multiple memory systems 410 and multiple host systems that may each include one or more processors. For example, a distributed memory system may operate according to a Compute Express Link (CXL) framework, such as a CXL.mem framework. The memory system may also have compute capabilities to support compute-near-memory functionalities-e.g., by using the processor 426 of memory system controller 412, media controller 420, or some other processor that is not shown.

As noted, the host 414, as well as memory system 410 can be integrated into a single host computing system. The host system can be in the form of a desktop computer, laptop computer, network server, mobile device, or such computing device that includes a memory and a processing device. The host system and/or the memory system 410 can be included in a variety of products, such as IoT devices (e.g., a refrigerator or other appliance, sensor, motor or actuator, mobile communication device, automobile, drone, etc.) to support processing, communications, or control of the product. The host system can include or be coupled to the host 414 and to the memory system 410 so that the host system can read data from or write data to the memory system 410. As used herein, “coupled to” generally refers to a connection between components, which can be an indirect communicative connection or direct communicative connection (e.g., without intervening components), whether wired or wireless, including connections such as, electrical, optical, magnetic, and the like.

The memory system 410 is configured with a memory system controller 412 that interfaces with the host 414. The host 414 may include a hardware processor, which may be a multi-core hardware processor, and communicates with the memory system controller 412 via a memory controller interface 413. Through this interface, the host 414 can issue commands to the memory system controller 412, such as a request to store data, which is accompanied by the data itself and potentially the target memory address for storage. In response, the memory system controller 412 can acknowledge the command and execute the data storage operation, providing confirmation back to the host 414 through the memory controller interface 413. Similarly, the host 414 is capable of sending a command to retrieve data, specifying the memory address from which to load the data. Upon receiving such a command, the memory system controller 412 retrieves the requested data and delivers it to the host 414 through the memory controller interface 413.

In certain embodiments, the host 414 and the memory system controller 412 are integrated onto a single die or different dies, but within a unified package. For example, in systems based on the x86 architecture, the memory system controller 412 is typically on the same die as the processor cores of host 414, thereby streamlining the memory access operations. Alternatively, there are configurations where the memory system controller 412 is situated on a distinct die, separate from that of the host 414 but within a same CPU package, allowing for modular design and potential customization of the memory system. In yet other examples, the memory system controller 412 may not be on the same die or package as the host 414.

The host 414 may communicate with the memory system controller 412 through a memory controller interface 413 and the memory system controller 412 may communicate with one or more memory modules 416A-416N upon which the physical memory is located through the memory module interface 418. In examples in which the memory system controller 412 is not on the same die or package as the host 414, the memory controller interface 413 may be the system bus, front-side bus, or other interface and the memory module interface 418 may be an internal bus of the memory system 410, such as internal pins or traces or some other interface such as an ONFI bus. In other examples, where the memory system controller 412 is on a same die or package as the host 414, the memory controller interface 413 may be one or more traces, pins, or some other interface and the memory module interface 418 may be a system bus.

The memory controller interface 413 and/or the memory module interface 418 may, depending on the design of the system, operate as one or more traces or pins, a Peripheral Component Interconnect-Express (PCIe) interface, a UFS interface, a serial advanced technology attachment (SATA) interface, a universal serial bus (USB) interface, an ONFI interface, a Fibre Channel interface, Serial Attached SCSI (SAS) interface, memory fabric, an eMMC interface, or the like.

The memory modules, designated as 416A through 416N, are capable of incorporating a diverse array of memory media 422, which may be either volatile or non-volatile in nature. The memory media 422 is comprised of elements such as memory cells, magnetic sectors, or equivalent data storage units. These memory modules can manifest in various configurations, including but not limited to Single Inline Memory Modules (SIMMs), Dual Inline Memory Modules (DIMMs), Solid State Drives (SSDs), embedded MultiMediaCards (eMMCs), Hard Disk Drives (HDDs), tape drives, among others. The memory media 422 within modules 416A-416N may encompass Random Access Memory (RAM), Static RAM (SRAM), Dynamic RAM (DRAM), Synchronous DRAM (SDRAM), NAND flash memory, magnetic media, phase-change memory (PCM), magneto-resistive random access memory (MRAM), NOR flash memory, electrically erasable programmable read-only memory (EEPROM), cross-point memory, and similar technologies. For instances where the memory media 422 consists of NAND-type memory, the configuration may involve a range of cell architectures, from single-level cells (SLCs) to multi-level cells (MLCs). MLCs may include triple-level cells (TLCs), quad-level cells (QLCs), and the like.

In some examples, the data storage units of the memory media 422 (such as memory cells) may be organized into one or more logical structures. For volatile storage, one example of a logical organization groups memory cells by ranks, banks, rows, and columns. For non-volatile storage, one example logical organization includes grouping cells into planes, sub-blocks, blocks, and/or pages. Other logical organizations may include sectors, tracks, cylinders, clusters, and so on.

In some examples, one or more of the memory modules 416A-416N may include a media controller 420 that may handle tasks such as accessing data from the memory media, writing data to the memory media, refreshing memory cells and communications over the memory module interface with the memory system controller 412. For example, the media controller 420 can parse a command and determine the affected memory cells from the memory media 422 and can read and/or write a desired value to those memory cells. Media controller 420 can be responsible for refreshing or otherwise maintaining the data stored in the memory media 422. In some examples, the media controller 420 may handle one or more of the functions traditionally associated with the memory system controller 412. In some examples, the memory modules 416A-N do not include a media controller 420.

The media controller 420 can include hardware such as one or more integrated circuits and/or discrete components, a buffer memory, or a combination thereof. The media controller 420 can be a microcontroller, special purpose logic circuitry (e.g., a field programmable gate array (FPGA), an application specific integrated circuit (ASIC), etc.), or other suitable processor(s). The media controller 420 can include a processor (processing device) configured to execute instructions stored in a local memory. Media controller 420 can also include address circuitry, row decoders, I/O circuitry write circuitry, column decoders, sensing circuitry, and other latches for decoding addresses, writing to, and reading from the memory media 422.

The local memory of the media controller 420 can include embedded memory configured to store instructions for performing various processes, operations, logic flows, and routines that control the memory media 422, including handling communications between the memory module 416A-416N and the memory system controller 412. In some embodiments, the local memory of the media controller 420 can include memory registers storing, e.g., memory pointers, fetched data, etc. The local memory can also include read-only memory (ROM) for storing micro-code.

The memory system controller 412 can include a processor 426 configured to execute instructions stored in a local memory 428. The processor 426 can be a microcontroller, special purpose logic circuitry (e.g., a field programmable gate array (FPGA), an application specific integrated circuit (ASIC), etc.), general purpose processor configured by software (e.g., firmware), or other suitable processor. In the illustrated example, the local memory 428 may store instructions for performing various processes, operations, logic flows, and routines that control operation of the memory system 410, including handling communications between the memory system 410 and the host 414 and communications between the memory system controller 412 and the memory modules 416A-416N. In some embodiments, the local memory 428 of the memory system controller 412 can include memory registers storing, e.g., memory pointers, fetched data, etc. The local memory can also include read-only memory (ROM) for storing micro-code.

Local memory 428 may also include various management tables such as translation tables translating logical addresses used by the host 414 into physical memory addresses that define a physical location of the memory cells. In other examples, the management tables can instead or additionally include information regarding block age, block erase count, error history, or one or more error counts (e.g., a write operation error count, a read bit error count, a read operation error count, an erase error count, etc.) for one or more blocks of memory cells coupled to the memory system controller 412.

As noted, the memory system controller 412 can receive commands or operations (memory access commands) from the host 414 (or other component of a host) and can convert the commands or operations into instructions or appropriate commands to achieve the desired access to the memory modules 416A to 416N. The memory system controller 412 can be responsible for other operations such as wear leveling operations (e.g., garbage collection operations, reclamation), error detection and error-correcting code (ECC) operations, refresh operations, encryption operations, caching operations, block retirement, and address translations between a logical block address and a physical block address that are associated with the memory modules 416A to 416N. The memory system controller 412 can further include interface circuitry to communicate with the processor via the memory controller interface 413. The interface circuitry can convert the commands received from the host 414 into command instructions to access the memory modules 416A to 416N over the memory module interface 418 as well as convert responses associated with the memory modules 416A to 416N into information for the host 414 or other component of the host system.

The memory system controller 412 may include a decoder 429 which decodes data received from the memory modules 416A-N. The decoder 429 may in some examples, be the components shown in FIG. 2-4 and may include an ECC component 450, which may be an LDPC circuit and include one or more buffers, HRD circuitry and HED circuitry. Decoder 429 may include one or more Error Detection (ED) components 460 which may be a CRC circuit that implements CRC circuits 122, 222, 221, 322, and 321. In some examples, the decoder 429 may also include a syndrome component, such as syndrome circuitry 330. In addition, and not shown for clarity, decoder 429 may include bypass logic for bypassing the ECC component 450 upon a successful CRC check.

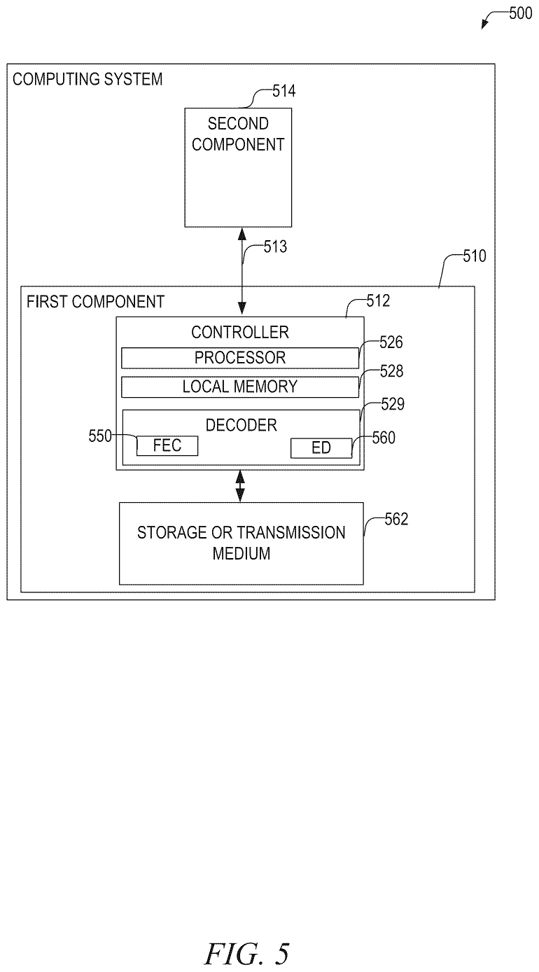

FIG. 5 illustrates a computing system 500 according to some examples of the present disclosure. Computing system 500 includes a first component 510 communicatively coupled to a second component 514. First component 510 includes storage or circuitry for communication across a transmission medium 562. Computing system 500 may include a controller 512, such as a processor; a local memory 528 for storing and handling instructions; and a decoder 529 for decoding data received from storage or the transmission medium 562. Controller 526 may control the transmission and reception of data between the storage or transmission medium 562 and/or the second component 514. In some examples, the controller 526 may process the data. Decoder 529 comprises an ECC decoder circuit 550, such as an LDPC decoder and an Error Detection (ED) circuit 560, which may be a CRC circuit. An example decoder 529 is shown in FIG. 1-3.

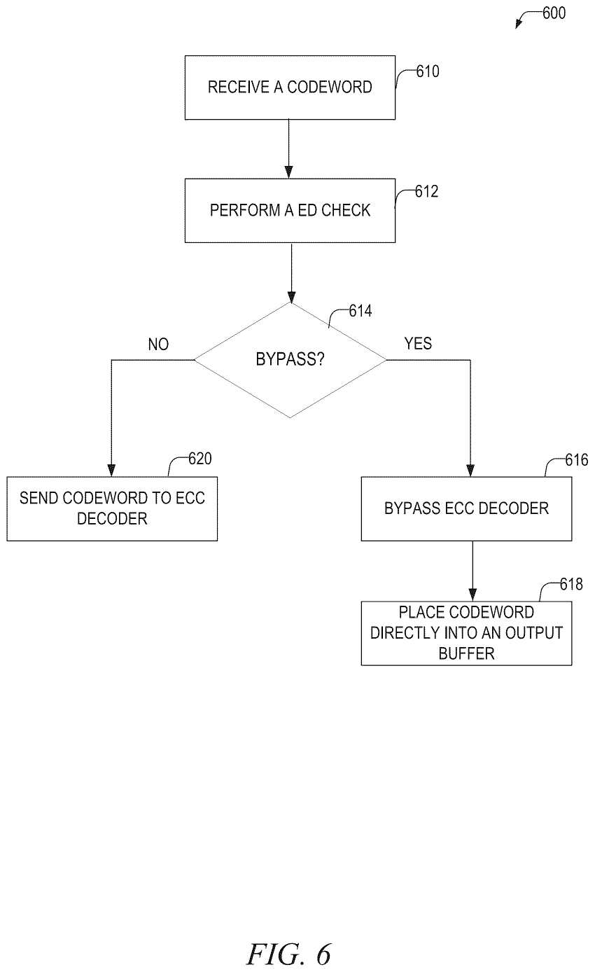

FIG. 6 illustrates a flowchart of a method 600 of ECC decoding bypass according to some examples of the present disclosure. At operation 610, the process begins with receiving a codeword. This involves acquiring a data block from a memory source or transmission medium, which is then subject to further processing.

At operation 612, the system performs an error detection check such as a Cyclic Redundancy Check (CRC). This involves calculating a checksum for the codeword to determine the error status, identifying whether the codeword contains errors that require correction.

At operation 614, a decision point evaluates the result of the error detection check (e.g., a CRC check). If the check passes, indicating that the codeword is error-free, the process proceeds to operation 616 to bypass the ECC decoder. This bypassing step allows the system to conserve resources by avoiding unnecessary decoding operations for error-free codewords.

Following the bypass decision, at operation 618, the codeword is placed directly into an output buffer. This involves storing the error-free codeword in a buffer that prepares it for transmission to a host device or further processing stages.

If the error check does not pass, indicating the presence of errors, at operation 620, the codeword is sent to the ECC (e.g., a LDPC) decoder. The ECC decoder applies iterative algorithms to correct any detected errors, ensuring the integrity and reliability of the data. Once the codeword is decoded by the ECC decoder, and passes an error detection check, it may be placed into the output buffer.

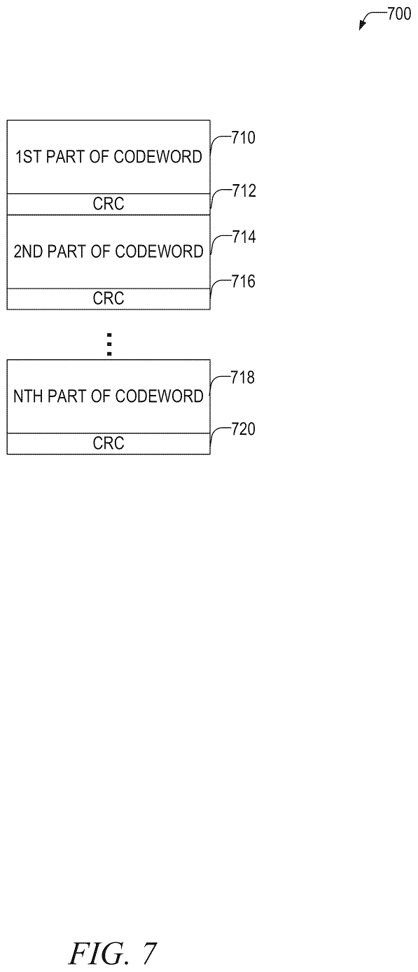

In some examples, to optimize the bypass, multiple CRC data per portion of the codeword may be utilized. FIG. 7 illustrates a diagram 700 showing a single codeword broken into N portions with CRC data for each portion according to some examples of the present disclosure. The first part of the codeword 710 is protected by CRC data 712; the second part of the codeword 714 is protected by CRC data 716 and so on until the Nth part of the codeword 718, which is protected by CRC 720. Breaking the codeword into multiple portions enhances the efficiency of error detection by allowing the system to identify and isolate errors within specific segments of a codeword. By focusing on smaller blocks, the system can more accurately determine which parts of the data require further processing, thereby optimizing the overall error correction process.

When a codeword is divided into multiple blocks, each block undergoes a separate CRC calculation. This granular approach enables the system to bypass the Low-Density Parity-Check (LDPC) decoding for blocks that pass the CRC check, significantly reducing unnecessary processing. Only the blocks that fail the CRC check are sent through the LDPC decoder for error correction. This selective processing not only conserves computational resources but also reduces power consumption and latency, enhancing the performance of the memory device.

The ability to apply CRC to smaller blocks also provides flexibility in handling varying error rates across different parts of a codeword. In scenarios where certain segments of data are more prone to errors, this method allows for targeted error correction, ensuring that only the necessary portions of the codeword undergo intensive processing. This approach is particularly beneficial in environments with fluctuating error conditions, as it adapts to the specific needs of each codeword, maintaining data integrity while optimizing resource usage.

In some examples, the bypass feature may be bypassed. This feature allows the system to deactivate the bypass mechanism when specific conditions are met, such as high temperatures, excessive erase counts, or prolonged retention times. By doing so, the system ensures that the error detection and correction processes remain robust and reliable, even under challenging conditions that may increase the likelihood of errors. This adaptability is particularly beneficial in environments where the memory device is subject to fluctuating conditions, ensuring that data integrity is maintained without compromising performance.

In some examples, the bypass deactivation may be implemented on a bypass shutdown condition such as one or more of: a temperatures over a threshold, erase counts over a second threshold, high error count reported from a previous decoded codeword (e.g., over a threshold), specific data types of the data being read, specific memory locations of the data being read (e.g. some locations may be more prone to errors or may require higher accuracy), a power mode of the device, an environment of the device associated with a high error rate (e.g., radiation environments), or retentions over a third threshold. In some examples, the shutdown conditions may be sent by a host to the memory device. For example, information about the device's environment may be determined based upon host information. In other examples, the device may self-determine various conditions, such as temperature, and the like.

Implementing a dynamic bypass deactivation protocol involves monitoring various device metrics that indicate the health and operational status of the memory system. For instance, temperature sensors can provide real-time data on the device's thermal state, while counters can track the number of erase cycles or retention periods. When these metrics exceed predefined thresholds, the system can automatically disable the CRC bypass, redirecting all codewords through the full LDPC decoding process. This proactive approach prevents potential data corruption by ensuring that even error-free codewords undergo thorough error correction when the risk of errors is heightened.

Moreover, the dynamic bypass deactivation feature can be tailored to specific application requirements, allowing for customizable thresholds and conditions based on the intended use case. For example, in applications where data integrity is paramount, the thresholds for bypass deactivation can be set more conservatively, ensuring maximum error correction. Conversely, in scenarios where performance and speed are prioritized, the system can allow for more lenient thresholds, maintaining the bypass functionality for longer periods. This flexibility makes the dynamic bypass deactivation feature a versatile tool for optimizing both the reliability and efficiency of memory systems across a wide range of applications.

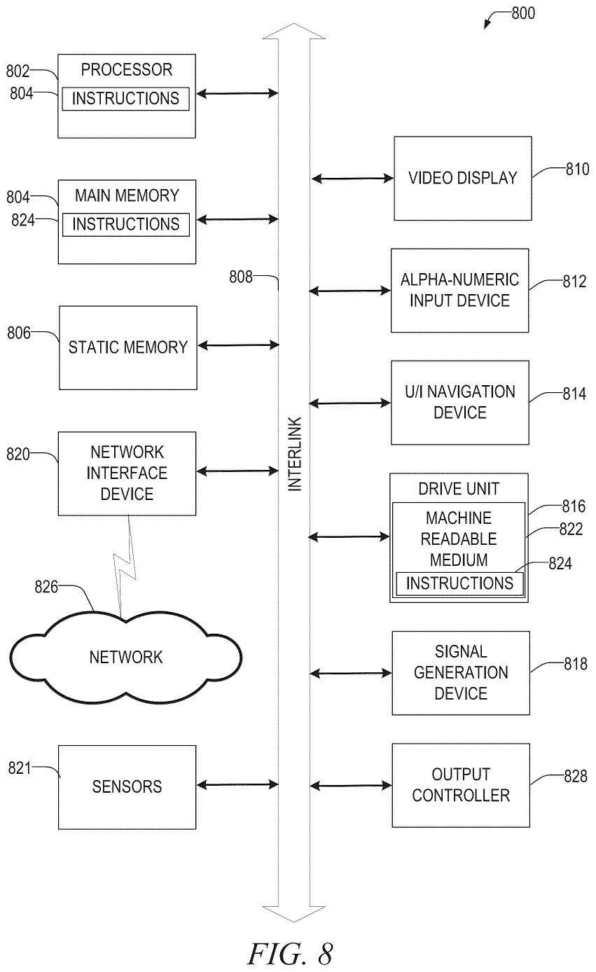

FIG. 8 illustrates a block diagram of an example machine 800 upon which any one or more of the techniques (e.g., methodologies) discussed herein may be performed. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be in the form of a computing system, memory device, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations of the component.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 800 may include one or more hardware processors, such as processor 802. Processor 802 may be a central processing unit (CPU), a graphics processing unit (GPU), a hardware processor core, or any combination thereof. Machine 800 may include a main memory 804 and a static memory 806, some or all of which may communicate with each other via an interlink (e.g., bus) 808. Examples of main memory 804 may include Synchronous Dynamic Random-Access Memory (SDRAM), such as Double Data Rate memory, such as DDR4 or DDR5. Interlink 808 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the one or more instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 824 may further be transmitted or received over a communications network 826 using a transmission medium via the network interface device 820. The Machine 800 may communicate with one or more other machines wired or wirelessly utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques.

### OTHER NOTES AND EXAMPLES

Example 1 is a method for optimizing error correcting code (ECC) decoding on a memory device, the method comprising: receiving a codeword from memory cells over a memory bus; performing an error detection calculation on the codeword to determine if the codeword is error-free; responsive to determining that the codeword is error-free: bypassing an ECC decoder; and outputting the codeword to a host device.

In Example 2, the subject matter of Example 1 includes, receiving a second codeword; performing an error detection calculation on the second codeword to determine if the second codeword is error-free; and responsive to determining that the second codeword is not error-free sending the second codeword to the ECC decoder.

In Example 3, the subject matter of Example 2 includes, performing a syndrome calculation on the second codeword as the error detection calculation is being performed; and responsive to determining that the second codeword is not error-free, passing the syndrome calculation to the ECC decoder.

In Example 4, the subject matter of Examples 1-3 includes, dividing the codeword into multiple blocks and performing a separate error detection calculation on each block.

In Example 5, the subject matter of Example 4 includes, processing any of the multiple blocks of the codeword in the ECC decoder if they fail the error detection calculation.

In Example 6, the subject matter of Examples 1-5 includes, determining that a device metric indicates a bypass shutdown condition; subsequent to determining that the device metric indicates a bypass shutdown condition: receiving a second codeword from the memory cells over the memory bus; and not performing an error detection calculation on the second codeword before processing in the ECC decoder, and instead, placing the codeword into an input buffer of the ECC decoder.

In Example 7, the subject matter of Example 6 includes,, wherein the bypass shutdown condition comprises one or more of: temperatures over a threshold, erase counts over a second threshold, high error count reported from a previous decoded codeword, specific data types, specific memory locations, a power mode of the device, an environment of the device associated with a high error rate, or retentions over a third threshold.

In Example 8, the subject matter of Examples 1-7 includes, wherein the ECC decoder is a Low Density Parity Check (LDPC) decoder and the error detection calculation is a Cyclic Redundancy Check.

Example 9 is a computing device for optimizing error correction coding (ECC) decoding, the computing device comprising: circuitry configured to perform operations comprising: receive a codeword from memory cells over a memory bus; perform an error detection calculation on the codeword to determine if the codeword is error-free; responsive to determining that the codeword is error-free, bypass an ECC decoder; and outputting the codeword to a host device.

In Example 10, the subject matter of Example 9 includes, wherein the operations further comprise: receive a second codeword; perform an error detection calculation on the second codeword to determine if the second codeword is error-free; and responsive to determining that the second codeword is not error-free, place the second codeword into an input buffer of the ECC decoder.

In Example 11, the subject matter of Example 10 includes, wherein the operations further comprise: perform a syndrome calculation on the second codeword as the error detection calculation is being performed; and responsive to determining that the second codeword is not error-free, pass the syndrome calculation to the ECC decoder.

In Example 12, the subject matter of Examples 9-11 includes, wherein the operations further comprise: divide the codeword into multiple blocks and performing a separate error detection calculation on each block.

In Example 13, the subject matter of Example 12 includes, wherein the operations further comprise: process any of the multiple blocks of the codeword in the ECC decoder if they fail the error detection calculation.

In Example 14, the subject matter of Examples 9-13 includes, wherein the operations further comprise: determine that a device metric indicates a bypass shutdown condition; subsequent to determining that the device metric indicates a bypass shutdown condition: receive a second codeword from the memory cells over the memory bus; and not performing an error detection calculation on the second codeword before processing in the ECC decoder, and instead, place the codeword into an input buffer of the ECC decoder.

In Example 15, the subject matter of Example 14 includes, wherein the bypass shutdown condition comprises one or more of: temperatures over a threshold, erase counts over a second threshold, high error count reported from a previous decoded codeword, specific data types, specific memory locations, a power mode of the device, an environment of the device associated with a high error rate, or retentions over a third threshold.

In Example 16, the subject matter of Examples 9-15 includes, wherein the ECC decoder is a Low Density Parity Check (LDPC) decoder and the error detection calculation is a Cyclic Redundancy Check.

Example 17 is a machine-readable medium, storing instructions for optimizing error correction coding decoding, the instructions, which when executed, cause the machine to perform operations comprising: receiving a codeword from memory cells over a memory bus; performing an error detection calculation on the codeword to determine if the codeword is error-free; responsive to determining that the codeword is error-free, bypassing an ECC decoder; and outputting the codeword to a host device.

In Example 18, the subject matter of Example 17 includes, wherein the operations further comprise: receiving a second codeword; performing an error detection calculation on the second codeword to determine if the second codeword is error-free; and responsive to determining that the second codeword is not error-free, sending the second codeword to the ECC decoder.

In Example 19, the subject matter of Example 18 includes, wherein the operations further comprise: performing a syndrome calculation on the second codeword as the error detection calculation is being performed; and responsive to determining that the second codeword is not error-free, passing the syndrome calculation to the ECC decoder.

In Example 20, the subject matter of Examples 17-19 includes, wherein the operations further comprise: dividing the codeword into multiple blocks and performing a separate error detection calculation on each block.

In Example 21, the subject matter of Example 20 includes, wherein the operations further comprise: processing any of the multiple blocks of the codeword in the ECC decoder if they fail the error detection calculation.

In Example 22, the subject matter of Examples 17-21 includes, wherein the operations further comprise: determining that a device metric indicates a bypass shutdown condition; subsequent to determining that the device metric indicates a bypass shutdown condition: receiving a second codeword from the memory cells over the memory bus; and not performing an error detection calculation on the second codeword before processing in the ECC decoder, and instead, placing the codeword into an input buffer of the ECC decoder.

In Example 23, the subject matter of Example 22 includes, wherein the bypass shutdown condition comprises one or more of: temperatures over a threshold, erase counts over a second threshold, high error count reported from a previous decoded codeword, specific data types, specific memory locations, a power mode of the device, an environment of the device associated with a high error rate, or retentions over a third threshold.

In Example 24, the subject matter of Examples 17-23 includes, wherein the ECC decoder is a Low Density Parity Check (LDPC) decoder and the error detection calculation is a Cyclic Redundancy Check.

Example 25 is at least one machine-readable medium including instructions that, when executed by processing circuitry, cause the processing circuitry to perform operations to implement of any of Examples 1-24.

Example 26 is an apparatus comprising means to implement of any of Examples 1-24.

Example 27 is a system to implement of any of Examples 1-24.

Example 28 is a method to implement of any of Examples 1-24.

What is claimed is:

1. A method for optimizing decoding of error correction coding (ECC) on a memory device, the method comprising:
receiving a codeword from memory cells over a memory bus;
performing an error detection calculation on the codeword to determine if the codeword is error-free;
responsive to determining that the codeword is error-free:
bypassing an ECC decoder; and
outputting the codeword to a host device.

2. The method of claim 1, further comprising:
receiving a second codeword;
performing an error detection calculation on the second codeword to determine if the second codeword is error-free; and
responsive to determining that the second codeword is not error-free sending the second codeword to the ECC decoder.

3. The method of claim 2, further comprising:
performing a syndrome calculation on the second codeword as the error detection calculation is being performed; and
responsive to determining that the second codeword is not error-free, passing the syndrome calculation to the ECC decoder.

4. The method of claim 1, further comprising:
dividing the codeword into multiple blocks and performing a separate error-detection calculation on each block.

5. The method of claim 4, further comprising:
processing any of the multiple blocks of the codeword in the ECC decoder if they fail the error detection calculation.

6. The method of claim 1, further comprising:
determining that a device metric indicates a bypass shutdown condition;
subsequent to determining that the device metric indicates a bypass shutdown condition:
receiving a second codeword from the memory cells over the memory bus; and
not performing an error detection calculation on the second codeword before processing in the ECC decoder, and instead, placing the codeword into an input buffer of the ECC decoder.

7. The method of claim 6, wherein the bypass shutdown condition comprises one or more of: temperatures over a threshold, erase counts over a second threshold, high error count reported from a previous decoded codeword, specific data types, specific memory locations, a power mode of the device, an environment of the device associated with a high error rate, or retentions over a third threshold.

8. The method of claim 1, wherein the ECC decoder is a Low Density Parity Check (LDPC) decoder and the error detection calculation is a Cyclic Redundancy Check.

9. A computing device for optimizing error correction coding (ECC) decoding, the computing device comprising:
circuitry configured to perform operations comprising:
receive a codeword from memory cells over a memory bus;
perform an error detection calculation on the codeword to determine if the codeword is error-free;
responsive to determining that the codeword is error-free, bypass a ECC decoder; and
outputting the codeword to a host device.

10. The computing device of claim 9, wherein the operations further comprise:
receive a second codeword;
perform an error detection calculation on the second codeword to determine if the second codeword is error-free; and
responsive to determining that the second codeword is not error-free, place the second codeword into an input buffer of the ECC decoder.

11. The computing device of claim 10, wherein the operations further comprise:
perform a syndrome calculation on the second codeword as the error detection calculation is being performed; and
responsive to determining that the second codeword is not error-free, pass the syndrome calculation to the ECC decoder.

12. The computing device of claim 9, wherein the operations further comprise:
divide the codeword into multiple blocks and performing a separate error-detection calculation on each block.

13. The computing device of claim 12, wherein the operations further comprise:
process any of the multiple blocks of the codeword in the ECC decoder if they fail the error detection calculation.

14. The computing device of claim 9, wherein the operations further comprise:
determine that a device metric indicates a bypass shutdown condition;
subsequent to determining that the device metric indicates a bypass shutdown condition:
receive a second codeword from the memory cells over the memory bus; and
not performing an error detection calculation on the second codeword before processing in the ECC decoder, and instead, place the codeword into an input buffer of the ECC decoder.

15. The computing device of claim 14, wherein the bypass shutdown condition comprises one or more of: temperatures over a threshold, erase counts over a second threshold, high error count reported from a previous decoded codeword, specific data types, specific memory locations, a power mode of the device, an environment of the device associated with a high error rate, or retentions over a third threshold.

16. The computing device of claim 9, wherein the ECC decoder is a Low Density Parity Check (LDPC) decoder and the error detection calculation is a Cyclic Redundancy Check.

17. A machine-readable medium, storing instructions for optimizing decoding of error correction coding (ECC), the instructions, which when executed, cause the machine to perform operations comprising:
receiving a codeword from memory cells over a memory bus;
performing an error detection calculation on the codeword to determine if the codeword is error-free;
responsive to determining that the codeword is error-free, bypassing a ECC decoder; and
outputting the codeword to a host device.

18. The machine-readable medium of claim 17, wherein the operations further comprise:
receiving a second codeword;
performing an error detection calculation on the second codeword to determine if the second codeword is error-free; and
responsive to determining that the second codeword is not error-free, sending the second codeword to the ECC decoder.

19. The machine-readable medium of claim 18, wherein the operations further comprise:
performing a syndrome calculation on the second codeword as the error detection calculation is being performed; and
responsive to determining that the second codeword is not error-free, passing the syndrome calculation to the ECC decoder.

20. The machine-readable medium of claim 17, wherein the operations further comprise:
dividing the codeword into multiple blocks and performing a separate error detection calculation on each block.
